(19) United States
(12) Patent Application Publication
(10) Pub. No.: US 2024/0418581 A1
(43) Pub. Date: Dec. 19, 2024

(54) TACTILE SENSOR, TOUCH DEVICE, AND MANUFACTURING METHOD OF TACTILE SENSOR

(71) Applicant: City University of Hong Kong, Hong Kong (HK)

(72) Inventors: Jinlian HU, Hong Kong (HK); Chuanwei ZHI, Hong Kong (HK); Shuo SHI, Hong Kong (HK)

(21) Appl. No.: 18/736,519

(22) Filed: Jun. 6, 2024

Related U.S. Application Data
(60) Provisional application No. 63/507,988, filed on Jun. 13, 2023.

(51) Int. Cl. G01L 1/00; G06F 3/041; H02N 1/04

(52) U.S. Cl. CPC G01L 1/005; G06F 3/041; H02N 1/04; G06F 2203/04103

(57) ABSTRACT

A tactile sensor comprising flexible electrodes and triboelectric layers is provided. The first triboelectric layer is disposed on the first flexible electrode. The second triboelectric layer is disposed on the second flexible electrode. The first and second triboelectric layers cover a same area. The first and second triboelectric layers are located between the first and second flexible electrodes. The second triboelectric layer keeps a distance from the first triboelectric layer when no external force is applied. The first triboelectric layer comprises MXene and polyvinylidene fluoride (PVDF). The first triboelectric layer and the second triboelectric layer have different triboelectric properties and form a triboelectric nanogenerator. A touch device comprising the tactile sensor and a manufacturing method of the tactile sensor are also provided.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to the field of tactile sensor. More specifically the present invention relates to tactile sensors comprising triboelectric nanogenerator.

### BACKGROUND OF THE INVENTION

Electronic textiles and textile with sensors have garnered significant research attention for their ability to capture physiological signals from users. These sensors are embedded in various wearable items such as shirts, pants, wristband, and more.

However, conventional electronic skins, sensors and gel electrodes are typically built on airtight substrates, which limit the exchange of gas or liquid between the human skin and the surrounding environment. This restriction can lead to interference from external heat or moisture, causing issues such as sweat accumulation, compromised signal acquisition, skin irritation, and discomfort during wear.

Moreover, rigid electrodes traditionally employed are often affixed to the skin or organs using clips, tape, puncture needles, or surgical implants, making them incompatible with natural human contact and resulting in distorted physical signals or significant noise.

Furthermore, the traditional method of battery charging is not portable, and the sensors generate a substantial amount of data during operation, leading to high power consumption. Consequently, there is a pressing need for innovation in this field.

### SUMMARY OF THE INVENTION

The present invention aims to address above challenges.

The present invention aims to provide a self-powered tactile sensor, touch device and manufacturing methods of the tactile sensor. In other words, the present invention aims to provide a tactile sensor with nanoscale perforations.

Also, the present invention aims to provide a self-powered tactile sensor, which generates its own power through conversion of mechanical energy (such as touch or movement) into electrical energy through triboelectric effect. The triboelectric effect describes electric charge transfer between two objects when they contact or slide against each other.

In accordance with a first aspect of the present invention, a tactile sensor including a first flexible electrode, a first triboelectric layer, a second flexible electrode, and a second triboelectric layer is provided. The first triboelectric layer is disposed on the first flexible electrode, and the second triboelectric layer is disposed on the second flexible electrode. The first and second triboelectric layers cover the same area when the tactile sensor is applied on a surface, and the first and second triboelectric layers are located between the first and second flexible electrodes. The second triboelectric layer keeps a distance from the first triboelectric layer when no external force is applied. The first triboelectric layer comprises MXene, a class of two-dimensional inorganic compounds with the structural formula of Mₙ₊₁XₙTₓ, where M represents the early transition metal (such as Ti, V, Zr and Nb), X stands for C and/or N elements, and T symbolizes the surface functional groups (e.g., —O, —OH and —F), that consist of atomically thin layers of transition metal carbides, nitride, or carbonitrides, and polyvinylidene fluoride (PVDF). The first and second triboelectric layers have different triboelectric properties and form a triboelectric nanogenerator.

In accordance with one embodiment of the present invention, a negatively enhanced nanofiber film is prepared as the negative electrode. Nylon fiber film is constructed by electrospinning as the positive electrode. The self-powered tactile sensor is assembled by using conductive fabric tape as the conductive electrode and foam tape as the interlayer. The tactile sensor of the invention has good air permeability and comfort, and at the same time has the function of monitoring the change of human physiological signal. The whole fibrous electronic textile has a simple preparation method, and has a wide application prospect in the fields of waterproof and permeable clothing, intelligent wearable electronics and physiological monitoring sensing.

In accordance with a second aspect of the present invention, a touch device comprising a plurality of the tactile sensors is provided. The touch device also includes an amplifier, a filter, a sensor processing unit (SPU), a microcontroller unit (MCU), a wireless transmitter, and a plurality of flexible wires. The flexible wires connect the tactile sensors, the amplifier, the filter, the SPU, the MCU, and the wireless transmitter.

In accordance with a third aspect of the present invention, a manufacturing method of the tactile sensor is provided. The manufacturing method includes: preparing a first triboelectric layer made of a first mixture; preparing a second triboelectric layer; disposing the first triboelectric layer on a first flexible electrode; disposing the second triboelectric layer on a second flexible electrode; and covering the first flexible electrode with the second flexible electrode. The first and second triboelectric layers cover a same area when the tactile sensor is applied on a surface. The first and second triboelectric layers are located between the first and second flexible electrodes. The second triboelectric layer keep a distance from the first triboelectric layer when no external force is applied. The first mixture comprises MXene and PVDF. The first triboelectric layer and the second triboelectric layer have different triboelectric properties and form a triboelectric nanogenerator.

In accordance with one embodiment of the present invention, the second triboelectric layer comprises Ag nanoparticles

In accordance with another embodiment of the present invention, the first and second triboelectric layers are made of nanofibers.

In accordance with another embodiment of the present invention, the first triboelectric layer is a PVDF nanofiber membrane, and the second triboelectric layer is a nylon nanofiber membrane.

In accordance with another embodiment of the present invention, a concentration of MXene in the first triboelectric layer ranges from 0.55 weight percent to 0.65 weight percent.

In accordance with another embodiment of the present invention, a β-phase content of the first triboelectric layer ranges from 74% to 76%, and a breaking strength of the first triboelectric layer ranges from 13.5 MPa to 14.5 MPa, and the β-phase content is calculated with a formula:

$$\frac{{Abr}_{β}}{( \frac{{k}_{β}}{{k}_{α}} ) {Abr}_{α} + {Abr}_{β}} ,$$

where Abr_{α} is an absorption intensity at wavenumber 762 cm⁻¹, Abr_{β} is an absorption intensity at wavenumber 840 cm⁻¹, k_{α} is an absorption factor at the corresponding wavenumber 762 cm⁻¹, and k_{α}=6.1×10⁴ cm²·mol⁻¹, k_{β} is an absorption factor at the corresponding wavenumber 840 cm⁻¹, and k_{β}=7.7×10⁴ cm²·mol⁻¹.

In accordance with another embodiment of the present invention, at 25 degree Celsius and 50% relative humidity, a water vapor transfer rate (WVTR) of the first triboelectric layer ranges from 19 kg·m⁻²·d⁻¹ to 20 kg·m⁻²·d⁻¹, and an air permeability (AP) of the first triboelectric layer ranges from 5 mL·s⁻¹ to 6 mL·s⁻¹, a WVTR of the second triboelectric layer ranges from 18.5 kg·m⁻²·d⁻¹ to 19.5 kg·m⁻²·d⁻¹, and an AP of the second triboelectric layer ranges from 1 mL·s⁻¹ to 2 mL·s⁻¹.

In accordance with another embodiment of the present invention, shapes of the first and second triboelectric layers of every tactile sensor are squares with the same dimension, and each side of every square ranges from 1 cm to 2 cm, and a 1 cm gap is formed between every two tactile sensors.

In accordance with another embodiment of the present invention, the step of preparing the first triboelectric layer comprises: adding MXene powder and PVDF particles into a first solvent and form the first mixture; forming a first membrane with the first mixture through electrospinning; and exsiccating the first membrane and form the first triboelectric layer.

In accordance with another embodiment of the present invention, the step of preparing the second triboelectric layer comprises: adding nylon 6,6 particles into formic acid (FA) and form a second mixture; adding AgNO₃ into the second mixture and wrap the second mixture with an opaque layer; vigorously stirring the second mixture; forming a second membrane with the second mixture through electrospinning; and exsiccating the second membrane and form the second triboelectric layer.

In an embodiment of the present invention, a tactile sensor can provide a triboelectric nanogenerator with perforations. Therefore, the tactile sensor offers superior liquid and air permeability while being self-powered. Also, the tactile sensor offers enhanced flexibility and durability, making it suitable for various wearable and interactive applications.

### BRIEF DESCRIPTION OF THE DRAWINGS

Embodiments of the invention are described in more details hereinafter with reference to the drawings, in which:

FIG. 1 is a schematic view of a tactile sensor according to an embodiment of the present invention;

FIG. 2 is a schematic view of a tactile sensor according to another embodiment of the present invention;

FIG. 3 is a schematic view of a touch device according to another embodiment of the present invention; and

FIG. 4 is a schematic view of a touch device according to another embodiment of the present invention.

### DETAILED DESCRIPTION

The contents of the invention will be further clarified in conjunction with examples in order to better understand the invention. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

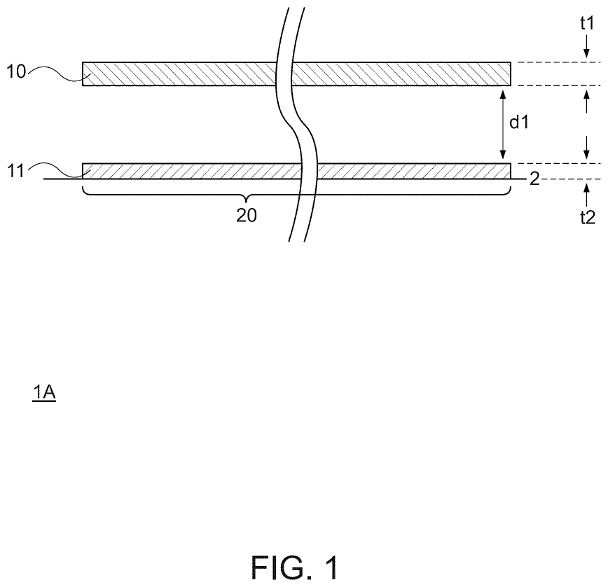

In an embodiment of the present invention, a tactile sensor is provided, and the tactile sensor has a triboelectric nanogenerator with two triboelectric layers. FIG. 1 is a schematic view of a tactile sensor according to an embodiment of the present invention. In accordance with FIG. 1, the tactile sensor 1A has a first triboelectric layer 10 and a second triboelectric layer 11.

In this tactile sensor 1A of the embodiment, the first triboelectric layer 10 is disposed on the second triboelectric layer 11, and the second triboelectric layer 11 keeps a distance d1 from the first triboelectric layer 10 when no external force is applied, i.e. in a neutral state. The first and second triboelectric layers 10 are flexible, and the first triboelectric layer 10 can touch the second triboelectric layer 11 when an external force is applied on the first triboelectric layer 10.

In this embodiment, the first triboelectric layer 10 and the second triboelectric layer 11 cover the same area. To be specific, when the tactile sensor is applied on a surface 2, the first and second triboelectric layers 10, 11 are both covering area 20 on the surface 2, and the tactile sensor 1A can generate touch signal corresponded to any pressing on the area 20 of the surface 2.

The material of the first and second triboelectric layers 10, 11 in this embodiment can induce triboelectric effect. To be specific, the first triboelectric layer 10 comprises MXene and PVDF, and the second triboelectric layer 11 has triboelectric property, i.e. a negative electric property, that is different from the first triboelectric layer 10. When the first triboelectric layer 10 touches the second triboelectric layer 11, the triboelectric effect is induced, and electricity signal is generated. Also, with the addition of MXene, the positive electricity property of the first triboelectric layer 10 is further enhanced. Therefore, the sensitivity of the tactile sensor 1A are improved, and the tactile sensor 1A is self-powered through the triboelectric effect.

In some embodiments, the first triboelectric layer 10 comprises MXene, a class of two-dimensional inorganic compounds, and PVDF. The two-dimensional inorganic compounds consist of atomically thin layers of transition metal carbides, nitride, or carbonitrides. In some other embodiments, the two-dimensional inorganic compounds has a structural formula of Mₙ₊₁XₙTₓ, where M represents early transition metal such as Ti, V, Zr, and Nb, and X stands for C and/or N elements, and T symbolizes the surface functional groups such as —O, —OH, or —F.

The distance d1 between the first and second triboelectric layers 10, 11 in this embodiment ranges from 0.8 millimetre (mm) to 1.2 mm. With the sufficient gap kept between the triboelectric layers 10, 11, the tactile sensor 1A can provide touch sensing with high signal-to-noise ratio.

Also, in this embodiment, the triboelectric layers 10, 12 have perforations in nanoscale, so the triboelectric layers 10, 12 can provide good permeability. They have good quality of allowing a liquid or gas to pass through.

Furthermore, referring to FIG. 1, thickness t1 of the first triboelectric layer 10 ranges from 55 to 65 m, and thickness t2 of the second triboelectric layer 11 ranges from 35 to 45 m. In this embodiment, the thickness t2 of the second triboelectric layer 11 is thinner than the thickness t1 of the first triboelectric layer 10. Therefore, the tactile sensor 1A can provide good permeability while the second triboelectric layer 11 is being the layer 11 attaching the surface 2 when, for example, the surface 2 is a part of human skin of a user.

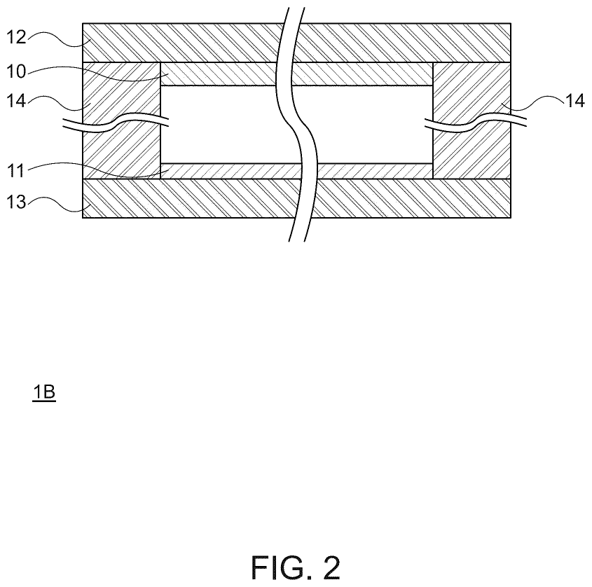

In another embodiment, a tactile sensor comprising a plurality of flexible electrodes is provided. FIG. 2 is a schematic view of a tactile sensor according to another embodiment of the present invention. In FIG. 2, the tactile sensor 1B comprises the first and second triboelectric layers 10, 11, a first flexible electrode 12, and a second flexible electrode 13.

In this tactile sensor 1B, the first triboelectric layer 10 is disposed on the first flexible electrode 12, and the second triboelectric layer 11 is disposed on the second flexible electrode 13. The flexible electrodes 12, 13 will serve as a proper electrical connection between the triboelectric nanogenerator formed by the first and second triboelectric layers 10, 11 and an external device. Also, the first and second flexible electrodes 12, 13 serve as a good and flexible carrier, i.e. substrate, for the first and second triboelectric layers 10, 11 respectively, to preserve good mechanical property as a touch sensor.

To be specific, the first and second triboelectric layers 10, 11 are located between the first and second flexible electrodes 12, 13, and the second triboelectric layer 11 keeps a distance from the first triboelectric layer 10 when no external force is applied. Therefore, the first triboelectric layer 10 can touch the second triboelectric layer 11 when an external force is applied on the tactile sensor 1B, and a touch signal will be generated with good sensitivity.

Also, the first and second flexible electrodes 12, 13 have good electrical conductivity and permeability. In this embodiment, the material of the first and second flexible electrodes 12, 13 can include conductive textile made of conductive fibers. In some other embodiments, the material of the flexible electrodes 12, 13 can include textile made of yarn coated with materials like silver, copper, or graphene.

The flexible electrodes 12, 13 of this embodiment are made of conductive fibers, and they also have a plurality of perforations, and the dimensions of the perforations in the flexible electrodes 12, 13 are much larger than the dimensions of the perforations in the triboelectric layers 10, 11. Most of the perforations in the triboelectric layers 10, 11 are aligned with the perforations in the flexible electrodes 12, 13, so the tactile sensor 1B can have good air and liquid permeability.

Furthermore, the first triboelectric layer 10 and the second triboelectric layer 11 in this embodiment are made of nanofibers. Therefore, the first triboelectric layer 10 and the second triboelectric layer 11 can have a plurality of perforations in nanoscale, and the first triboelectric layer 10 and the second triboelectric layer 11 can be properly disposed on the first flexible electrode 12 and the second flexible electrode 13.

In this embodiment, the first triboelectric layer 10 is a PVDF nanofiber membrane. With the PVDF nanofibers and the MXene, the first triboelectric layer 10 can have triboelectric property with negative voltage.

The second triboelectric layer 11 is a nylon nanofiber membrane. With the nylon nanofiber and the Ag nanoparticles, the second triboelectric layer 11 can have triboelectric property with positive voltage. Furthermore, the second triboelectric layer 11 comprises nylon 6, 6 nanofibers, so the second triboelectric layer 11 can provide good triboelectric property with sufficient positive voltage.

In this embodiment, the tactile sensor 1B has a plurality of spacers 14 disposed between the flexible electrodes 12, 13. The spacers 14 are pieces of foam tape material used to create or maintain a space between the first and second triboelectric layers 10, 11.

To be specific, the spacers 14 are disposed on the periphery of the flexible electrodes 12, 13, and the spacers 14 surrounds the triboelectric layers 10, 11. Therefore, the spacers 14 maintain a proper gap between the triboelectric layers 10, 11 and provide a good protection for the triboelectric layers 10, 11.

Also, in this embodiment, the second triboelectric layer 11 is antibacterial, and, when the tactile sensor 1B is applied on a user skin, the triboelectric layer 11 is covering the skin with the flexible electrode 13, and the tactile sensor 1B thereon can provide an antibacterial application with the second triboelectric layer 11.

To be specific, the second triboelectric layer 12 comprises silver (Ag) nanoparticles. Ag nanoparticles has been proved with excellent antibacterial properties, and the second triboelectric layer 12 can provide excellent antibacterial efficiency.

In some embodiments of the present invention, the flexible electrode 13 may also comprise Ag nanoparticles, so as to enhance the antibacterial ability.

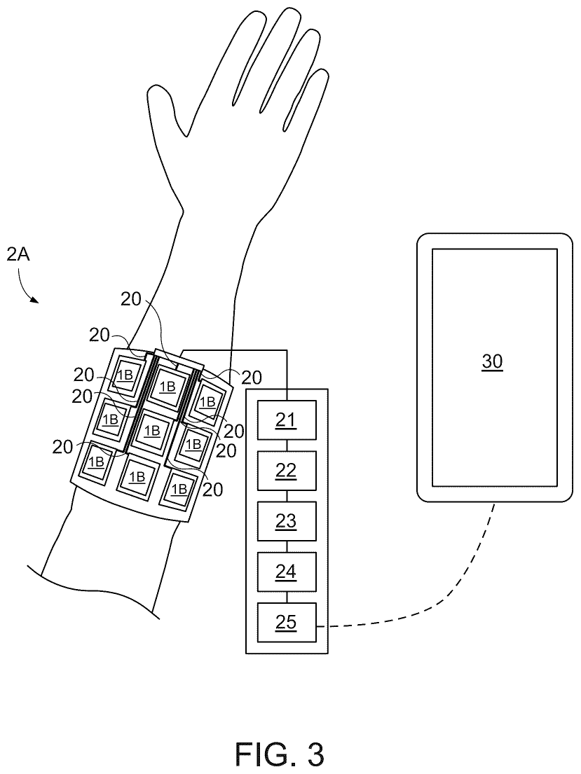

In another embodiment of the present invention, a touch device comprised a plurality of tactile sensors with triboelectric nanogenerator is provided. FIG. 3 is a schematic view of a touch device according to an embodiment of the present invention. In FIG. 3, the touch device 2A comprises a plurality of tactile sensors 1B as shown in the embodiment above.

The touch device 2A of this embodiment further comprises an amplifier 21, a filter 22, a SPU 23, a MCU 24, a wireless transmitter 25, and a plurality of flexible wires 20. The flexibles wires 20 connect the tactile sensors 1B, the amplifier 21, the filter 22, the SPU, 23, the MCU 24, and the wireless transmitter 25.

The tactile sensors 1B are attached on a user's arm, and the amplifier 21 is connected between the tactile sensors 1B and the filter 22. The amplifier 21 in the device serves a crucial role in enhancing the signals received from the tactile sensors 1B before they undergo further processing. By amplifying the signals, the amplifier 21 increases their strength and clarity, making them easier to detect and analyze. This amplification helps to improve the sensitivity and accuracy of the tactile sensors 1B, allowing it to capture even subtle tactile stimuli more effectively. Additionally, the amplifier 21 can adjust the gain of the signals, enabling the device 2A to adapt to different input levels and environmental conditions. This feature ensures that the device 2A can accurately detect and respond to a wide range of tactile inputs with precision and reliability. Overall, the amplifier 21 plays a vital role in optimizing the performance of the tactile sensors 1B and enhancing the overall functionality and effectiveness of the device 2A.

The filter 22 is connected between the amplifier 21 and the SPU 23. The filter 22 positioned between the amplifier 21 and the SPU 23 serves to refine the amplified signals received from the tactile sensors 1B. Its primary function is to eliminate unwanted noise, interference, or extraneous signals that may have been introduced during the amplification process or picked up from the environment. By selectively attenuating specific frequencies or components of the signal, the filter 22 enhances the signal-to-noise ratio, improving the overall quality and reliability of the data processed by the SPU 23. Moreover, the filter 22 can be configured to isolate and extract specific frequency bands or characteristics relevant to the tactile stimuli being detected, enabling the device 2A to focus on relevant tactile information while disregarding irrelevant background noise. This filtering process helps to enhance the accuracy, sensitivity, and responsiveness of the SPU 23, ultimately leading to more precise and reliable tactile sensing capabilities in the device.

The SPU 23 is connected between the filter 22 and the MCU 24. The SPU 23 acts as the intermediary between the filter 22 and the MCU 24, responsible for interpreting and analyzing the refined signals received from the tactile sensors 1B. Its primary function is to process and extract meaningful information from the filtered signals, converting raw data into actionable insights. This processing may involve various tasks such as signal conditioning, feature extraction, pattern recognition, or classification algorithms tailored to the specific application requirements. Additionally, the SPU 23 can perform real-time analysis to detect and identify tactile patterns or events of interest, enabling the device to respond promptly and accurately to tactile stimuli. Furthermore, it may incorporate advanced signal processing techniques to enhance signal quality, mitigate disturbances, and optimize performance in dynamic or challenging environments. Overall, the SPU 23 plays a pivotal role in transforming raw tactile data into valuable insights and commands that drive the functionality and responsiveness of the device.

The MCU 24 is connected between the SPU 23 and the wireless transmitter 25. The MCU 24 serves as the central control hub within the device 2A, bridging the gap between the SPU 23 and the wireless transmitter 25. Its primary function is to coordinate and manage the flow of data between these components while overseeing the overall operation of the device 2A. The MCU 24 is equipped with computational capabilities, enabling it to execute complex algorithms, decision-making processes, and communication protocols. It processes the refined tactile data received from the SPU 23, performing tasks such as data fusion, context awareness, or intelligent decision-making to derive meaningful insights or commands. Additionally, the MCU 24 coordinates the transmission of data wirelessly to external devices or networks via the wireless transmitter 25, facilitating real-time communication and remote monitoring. Furthermore, it may incorporate power management features, memory storage, and firmware updates to ensure efficient operation and scalability of the device. In essence, the MCU 24 acts as the brain of the device 2A, orchestrating its functionality and enabling seamless interaction with the surrounding environment.

The wireless transmitter 25 serves as the communication gateway for the device, facilitating the transmission of data from the MCU 24 to external devices (i.e., smart phone 30) or networks without the need for physical connections. Its primary function is to encode the processed signals into a suitable wireless format and transmit them over a designated communication protocol, such as Bluetooth, Wi-Fi, or Zigbee. This wireless capability enables the device 2A to communicate seamlessly with other compatible devices (i.e., smart phone 30) or systems over short or long distances, depending on the transmission range and power requirements. Additionally, the wireless transmitter 25 may support bidirectional communication, allowing the device 2A to receive commands or updates from external sources, enhancing its versatility and interoperability. Furthermore, it may incorporate security features such as encryption or authentication mechanisms to ensure the confidentiality and integrity of the transmitted data, safeguarding against unauthorized access or tampering. Overall, the wireless transmitter 25 empowers the device 2A with connectivity, enabling remote monitoring, control, and collaboration in various applications and environments.

In this embodiment, the touch device 2A can serve as a wireless control panel with the tactile sensors 1B serve as multiple programmable interfaces. The touch device 2A can provide a remote control with high sensitivity, and low power consumption due to the self-powered tactile sensors 1B.

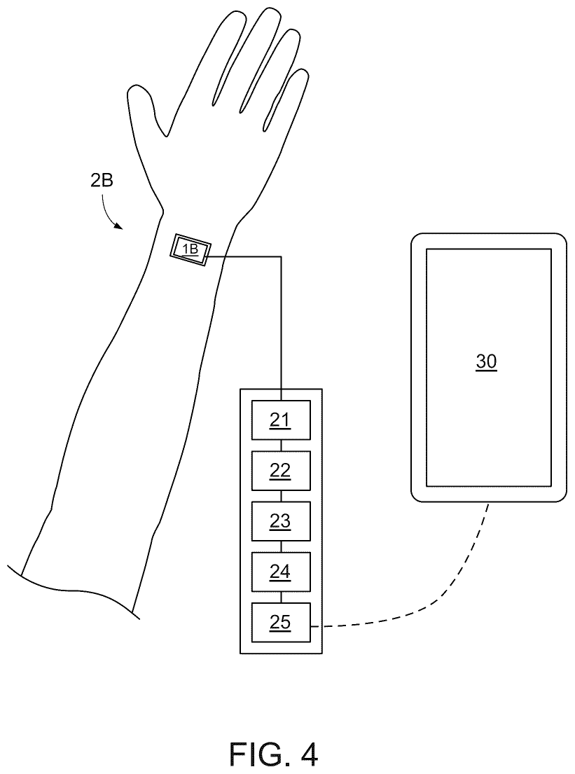

In some other embodiments, a touch device with the tactile sensor 1B can serve as a pulse monitoring device. FIG. 4 is a schematic view of a touch device according to another embodiment of the present invention. In FIG. 4, the touch device 2B comprises only one tactile sensor 1B that is attached on the wrist of a user, and the tactile sensor 1B is connected to the amplifier 21, the filter 22, the SPU 23, the MCU 24, and the wireless transmitter 25 sequentially.

The tactile sensor 1B can detect the pulse from the user's wrist, and, after the signal from the tactile sensor 1B is processed by the amplifier 21, the filter 23, the SPU 23, and the MCU 24, the processed signal is transmitted through the wireless transmitter 25 and received by the smart phone 30. Therefore, the touch device 2B can provide a pulse recorder with low power consumption and high air and liquid permeability.

Referring to FIG. 3, in this embodiment, the shapes of the triboelectric layers of every tactile sensor 1B are squares with the same dimension, and each side of every square ranges from 1 centimetre (cm) to 2 cm, and a 1 cm gap is formed between every two tactile sensors.

Firstly, in this embodiment, this design allows for precise and localized tactile sensing, enabling the detection of fine-grained tactile information. The sensors' dimensions matching finger tips enhance the user experience by providing a natural and intuitive interaction interface, mimicking the tactile feedback experienced during manual tasks. Additionally, the sufficient gap between sensors 1B minimizes interference and crosstalk, ensuring accurate and independent sensing from each sensor 1B. This configuration is particularly beneficial for applications such as human-computer interfaces, virtual reality systems, and robotic manipulation, where high-fidelity tactile feedback and dexterous control are paramount. Overall, the combination of matched dimensions and adequate spacing in these tactile sensors 1B enhances their sensitivity, precision, and usability for various interactive and haptic applications.

In some embodiment, the first triboelectric layer is made of a mixture comprising MXene and PVDF. In an embodiment, the manufacturing method of a tactile sensor comprising: preparing a first triboelectric layer made of a first mixture; preparing a second triboelectric layer; disposing the first triboelectric layer on a first flexible electrode; disposing the second triboelectric layer on a second flexible electrode; and covering the first flexible electrode with the second flexible electrode. The first and second triboelectric layers and the first and second flexible electrodes can refer to the tactile sensors or touch device in any of the embodiments above, and the following will describe the detailed description about the steps of the manufacturing method without repeating the same description that can be referred in the above embodiment.

The first mixture comprises MXene and PVDF, and the second triboelectric layer have triboelectric property that is different from the first triboelectric layer. Therefore, the manufacturing method can provide a tactile sensor with good touch sensing ability through triboelectric effect.

To be specific, the step of preparing the first triboelectric layer comprises: adding MXene powder and PVDF particles into a first solvent and form the first mixture; forming a first membrane with the first mixture through electrospinning; and exsiccating the first membrane and form the first triboelectric layer.

In this embodiment, the first solvent includes Dimethylformamide (DMF) and Acetone, with a ration of 3 parts DMF to 2 parts Acetone. The concentration of the mixed MXene powder and PVDF particles in the first solvent is 15 weight percent. The electrospinning uses a 21 gauge needle as a nozzle. The feeding rate is 0.05 mm/min. The voltage applied on the nozzle and a collector is 25 kV and −2 kV respectively, and a distance between the nozzle and the collector is 15 cm. The sweep distance of the needle is 10 cm, and the spinning time is 6 hours.

The first membrane is exsiccated at 60 degree Celsius for 12 hours, and the provided first triboelectric layer's thickness is 60 m. A concentration of MXene in the first triboelectric layer ranges from 0.55 weight percent to 0.65 weight percent. Therefore, the first triboelectric layer has good β-phase content and breaking strength, and the first triboelectric layer can provide good electrical and mechanical properties.

To be specific, in this embodiment, the β-phase of the first triboelectric layer ranges from 74% to 76%, and the breaking strength ranges from 13.5 MPa to 14.5 MPa.

Also, the first triboelectric layer of this embodiment can provide good WVTR and AP. At 25 degree Celsius and 50% relative humidity, the WVTR of the first triboelectric layer ranges from 19 kg·m⁻²·d⁻¹ to 20 kg·m⁻²·d⁻¹, and the AP of the first triboelectric layer ranges from 5 mL·s⁻¹ to 6 mL·s⁻¹.

In this embodiment, the step of preparing the second triboelectric layer comprises: adding nylon 6,6 particles into FA and form a second mixture; adding AgNO₃ into the second mixture and wrap the second mixture with an opaque layer; vigorously stirring the second mixture; forming a second membrane with the second mixture through electrospinning; and exsiccating the second membrane and form the second triboelectric layer. Therefore, the second triboelectric layer comprises Ag nanoparticles and nylon nanofiber, and the second triboelectric layer has good triboelectric property and antibacterial property.

To be specific, before adding the AgNO₃, the second mixture is made with intensive stirring at 55 degree Celsius for 6 hours, and the concentration of the nylon 6,6 particles is 15 weight percent.

After adding the AgNO₃, the second mixture is vigorously stirred for 12 hours to enable sufficient silver ion reduction.

During the process of electrospinning, a 21 gauge needle is used as a nozzle. Voltage applied on the nozzle and the collector is 20 kV and −2 kV respectively. Distance between the needle and the collector is 15 cm. The feeding rate of the nozzle is 0.0015 mm/min. The sweep distance of the needle is 12 cm, and the spinning time of the collector is 18 hours.

In this embodiment, the second membrane is exsiccated at 60 degree Celsius for 12 hours, and the provided second triboelectric layer's thickness is 40 m.

The concentration of the AgNO3 in the second mixture is 1 weight percent, and the provided second triboelectric layer has good WVTR and AP. To be specific, at 25 degree Celsius and 50% relative humidity, the WVTR of the second triboelectric layer ranges from 18.5 kg·m⁻²·d⁻¹ to 19.5 kg·m⁻²·d⁻¹, and the AP of the second triboelectric layer ranges from 1 mL·s⁻¹ to 2 mL·s⁻¹.

Following are some further examples of the preparation of the triboelectric layers.

### Example 1

The present example includes the following steps:

Preparation of spinning solution A: 3 g of hydrophobic PVDF and 0.06 g of titanium carbide powder are added into 20 g of DMF organic solvent, and stirred at 40° C. for 4 hours to obtain high viscosity black spinning solution A, which is stored at room temperature for use.

Preparation of a first triboelectric layer: the aluminum foil is used as the collection substrate and wound on the roller. The spinning solution A is ejected by the single-needle spinning device and nanofibers are collected on the aluminum foil under 25 kV through electrospinning.

The flow rate of the injection pump is set as 0.03 mm/min, the receiving distance is 15 cm, and the spinning time is 360 min.

Finally, the first triboelectric layer is removed from the roller and set aside at room temperature. Through a scanning electron microscope image, it can be seen that 0.3% titanium carbide functionalized PVDF electrospinning nanofibers randomly distributed to form porous fibrous membrane.

Preparation of spinning solution B: 2 g of nylon 6,6 is added to 20 g of FA solvent and stirred at 50° C. for 4 hours to obtain high viscosity and transparent spinning solution B, which is reserved at room temperature.

Preparation of a second triboelectric layer: aluminum foil is used as the collection substrate and wound on a roller. The spinning solution B is ejected by a single-needle spinning device under 25 kV and the nanofibers are collected on the aluminum foil. The flow rate of injection pump is set as 0.01 mm/min, the receiving distance is 18 cm, and the spinning time is 360 min.

Finally, the second triboelectric layer is removed from the roller and set aside at room temperature. Through a scanning electron microscope image, it can be seen that nylon 6, 6 nanofibers randomly spread to form porous nanofibers film.

The first triboelectric layer and the second triboelectric layer are clipped to obtain the same size of the fiber film, the area is 1×1 cm². One side of the first triboelectric layer and the second triboelectric layer are bonded through a single-side conductive fabric tape as a conductive electrode. Finally, the first triboelectric layer prepared above is interfaced with the unfitted side of the second triboelectric layer with conductive fabric prepared above. Spacer including foam tape is used as a gap sandwich on the two edges, and the thickness and length of the foam tape are 1 mm and 1 cm. Finally, the tactile sensor is prepared.

### Example 2

The present example includes the following steps:

Preparation of spinning solution A: 4 g of hydrophobic PVDF and 0.1 g of graphene oxide powder are added into 20 g of mixed solvent of DMF and Acetone (mass ratio 7:3), and stirred at 40° C. for 4 hours to obtain high viscosity black spinning solution A, which is stored at room temperature for use.

Preparation of first triboelectric layer: the aluminum foil is used as the collection substrate and wound on the roller. The spinning solution A is ejected by the single-needle spinning device and the nanofibers are collected on the aluminum foil under 25 kV through electrospinning. The flow rate of the injection pump is set as 0.04 mm/min, the receiving distance is 15 cm, and the spinning time is 360 min. Finally, the first triboelectric layer is removed from the roller and set aside at room temperature.

Preparation of spinning solution B: 2 g of nylon 6,6 is added to 20 g of FA solvent and stirred at 50° C. for 4 hours to obtain high viscosity and transparent spinning solution B, which is reserved at room temperature.

Preparation of second triboelectric layer: aluminum foil is used as the collection substrate and wound on a roller. The spinning solution B is ejected by a single-needle spinning device under 25 kV and the nanofibers are collected on the aluminum foil. The flow rate of injection pump is set as 0.01 mm/min, the receiving distance is 18 cm, and the spinning time is 360 min. Finally, the second triboelectric layer is removed from the roller and set aside at room temperature.

The first triboelectric layer and the second triboelectric layer are clipped to obtain the same size of the fiber film, the area is 1×1 cm²; Then, one side of the first triboelectric layer and the second triboelectric layer are bonded through a single-side conductive fabric tape as a conductive electrode. Finally, the first triboelectric layer is interfaced with the unfitted side of the second triboelectric layer with conductive fabric prepared above. Spacer including foam tape is used as a gap sandwich on the two edges, and the thickness and length of the foam tape are 1 mm and 1 cm. Finally, the tactile sensor is prepared.

### Example 3

The present example prepares a tactile sensor, including the following steps:

Preparation of spinning solution A: 3 g of hydrophobic PVDF and 0.12 g of titanium carbide powder are added into 20 g of mixed solvent of DMF and Acetone (mass ratio 7:3), and stirred at 40° C. for 4 h to obtain high viscosity black spinning solution A, which is stored at room temperature for use.

Preparation of first triboelectric layer: the aluminum foil is used as the collection substrate and wound on the roller. The spinning solution A is ejected by the single-needle spinning device and the nanofibers are collected on the aluminum foil under 25 kV through electrospinning. The flow rate of the injection pump is set as 0.03 mm/min, the receiving distance is 15 cm, and the spinning time is 360 min. Finally, the first triboelectric layer is removed from the roller and set aside at room temperature. In a scanning electron microscope image, it can be seen that 0.6% titanium carbide functionalized PVDF electrospinning nanofibers randomly distributed to form porous fibrous membrane.

Preparation of spinning solution B: 3 g of nylon 6 is added to 20 g of FA solvent and stirred at 50° C. for 4 hours to obtain high viscosity and transparent spinning solution B, which is reserved at room temperature.

Preparation of second triboelectric layer: aluminum foil is used as the collection substrate and wound on a roller. The spinning solution B is ejected by a single-needle spinning device under 25 kV and the second triboelectric layer are collected on the aluminum foil through electrospinning. The flow rate of injection pump is set as 0.02 mm/min, the receiving distance is 15 cm, and the spinning time is 360 min. Finally, the second triboelectric layer is removed from the roller and set aside at room temperature.

The first triboelectric layer and the second triboelectric layer are clipped to obtain the same size of the fiber film, the area is 1×1 cm²; Then, one side of the first triboelectric layer and the second triboelectric layer are bonded through a single-side conductive fabric tape as a conductive electrode. Finally, the first triboelectric layer is interfaced with the unfitted side of the second triboelectric layer with conductive fabric prepared above. Spacer including foam tape is used as a gap sandwich on the two edges, and the thickness and length of the foam tape are 1 mm and 1 cm. Finally, the tactile sensor is prepared.

### Example 4

The present example prepares a tactile sensor, including the following steps:

Preparation of spinning solution A: 3 g of hydrophobic PVDF-HFP and 0.3 g of carbon nanotubes powder are added into 20 g of mixed solvent of DMF and Acetone (mass ratio 7:3), and stirred at 40° C. for 4 hours to obtain high viscosity black spinning solution A, which is stored at room temperature for use.

Preparation of first triboelectric layer: the aluminum foil is used as the collection substrate and wound on the roller. The spinning solution A is ejected by the single-needle spinning device and the first triboelectric layer is collected on the aluminum foil under 25 kV. The flow rate of the injection pump is set as 0.025 mm/min, the receiving distance is 15 cm, and the spinning time is 360 min. Finally, the first triboelectric layer is removed from the roller and set aside at room temperature.

Preparation of spinning solution B: 4 g of nylon 6,6 is added to 20 g of FA solvent and stirred at 50° C. for 4 hours to obtain high viscosity and transparent spinning solution B, which is reserved at room temperature.

Preparation of second triboelectric layer: aluminum foil is used as the collection substrate and wound on a roller. The spinning solution B is ejected by a single-needle spinning device under 25 kV and the second triboelectric layer is collected on the aluminum foil. The flow rate of injection pump is set as 0.03 mm/min, the receiving distance is 15 cm, and the spinning time is 360 min. Finally, the second triboelectric layer is removed from the roller and set aside at room temperature.

The first triboelectric layer and the second triboelectric layer are clipped to obtain the same size of the fiber film, the area is 2×2 cm²; Then, one side of the first triboelectric layer and the second triboelectric layer are bonded through a single-side conductive fabric tape as a conductive electrode. Finally, the first triboelectric layer is interfaced with the unfitted side of the second triboelectric layer with conductive fabric prepared above. Spacer including foam tape is used as a gap sandwich on the two edges, and the thickness and length of the foam tape are 1 mm and 2 cm. Finally, the tactile sensor is prepared.

### Example 5

The present example prepares a tactile sensor, including the following steps:

Preparation of spinning solution A: 4 g of hydrophobic PVDF-HFP and 0.2 g of titanium carbide powder are added into 20 g of mixed solvent of DMF and Acetone (mass ratio 7:3), and stirred at 40° C. for 4 hours to obtain high viscosity black spinning solution A, which is stored at room temperature for use.

Preparation of first triboelectric layer: the aluminum foil is used as the collection substrate and wound on the roller. The spinning solution A is ejected by the single-needle spinning device and the first triboelectric layer is collected on the aluminum foil under 25 kV through electrospinning. The flow rate of the injection pump is set as 0.035 mm/min, the receiving distance is 15 cm, and the spinning time is 360 min. Finally, the first triboelectric layer is removed from the roller and set aside at room temperature.

Preparation of spinning solution B: 4 g of nylon 6 is added to 20 g of FA solvent and stirred at 50° C. for 4 hours to obtain high viscosity and transparent spinning solution B, which is reserved at room temperature.

Preparation of second triboelectric layer: aluminum foil is used as the collection substrate and wound on a roller. The spinning solution B is ejected by a single-needle spinning device under 25 kV and the second triboelectric layer is collected on the aluminum foil through electrospinning. The flow rate of injection pump is set as 0.03 mm/min, the receiving distance is 15 cm, and the spinning time is 360 min. Finally, the second triboelectric layer is removed from the roller and set aside at room temperature. Through a scanning electron microscope image, it can be seen that nylon 6 electrospinning nanofibers randomly distributed to form porous fibrous membrane.

The first triboelectric layer and the second triboelectric layer are clipped to obtain the same size of the fiber film, the area is 1×1 cm²; Then, one side of the first triboelectric layer and the second triboelectric layer are bonded through a single-side conductive fabric tape as a conductive electrode. Finally, the first triboelectric layer is interfaced with the unfitted side of the second triboelectric layer with conductive fabric prepared above. Spacer including foam tape is used as a gap sandwich on the two edges, and the thickness and length of the foam tape are 1 mm and 1 cm. Finally, the tactile sensor is prepared.

### Example 6

The present example prepares a tactile sensor, including the following steps:

Preparation of spinning solution A: 3 g of hydrophobic PVDF and 0.3 g of titanium carbide powder are added into 20 g of mixed solvent of DMF and Acetone (mass ratio 5:5), and stirred at 40° C. for 4 hours to obtain high viscosity black spinning solution A, which is stored at room temperature for use.

Preparation of first triboelectric layer: the aluminum foil is used as the collection substrate and wound on the roller. The spinning solution A is ejected by the single-needle spinning device and the first triboelectric layer is collected on the aluminum foil under 25 kV through electrospinning. The flow rate of the injection pump is set as 0.015 mm/min, the receiving distance is 15 cm, and the spinning time is 360 min. Finally, the first triboelectric layer is removed from the roller and set aside at room temperature.

Preparation of spinning solution B: 3 g of nylon 6, 6 is added to 20 g of FA solvent and stirred at 50° C. for 4 hours to obtain high viscosity and transparent spinning solution B, which is reserved at room temperature.

Preparation of second triboelectric layer: aluminum foil is used as the collection substrate and wound on a roller. The spinning solution B is ejected by a single-needle spinning device under 25 kV and the second triboelectric layer is collected on the aluminum foil. The flow rate of injection pump is set as 0.01 mm/min, the receiving distance is 18 cm, and the spinning time is 360 min. Finally, the second triboelectric layer is removed from the roller and set aside at room temperature.

The first triboelectric layer and the second triboelectric layer are clipped to obtain the same size of the fiber film, the area is 1×1 cm²; Then, one side of the first triboelectric layer and the second triboelectric layer are bonded through a single-side conductive fabric tape as a conductive electrode. Finally, the first triboelectric layer prepared above is interfaced with the unfitted side of the second triboelectric layer with conductive fabric prepared above. Spacer including foam tape is used as a gap sandwich on the two edges, and the thickness and length of the foam tape are 1 mm and 1 cm. Finally, the tactile sensor is prepared.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments are chosen and described in order to best explain the principles of the invention and its practical application, thereby enabling others skilled in the art to understand the invention for various embodiments and with various modifications that are suited to the particular use contemplated.

1. A tactile sensor, comprising:
a first flexible electrode;
a first triboelectric layer, disposed on the first flexible electrode;
a second flexible electrode; and
a second triboelectric layer, disposed on the second flexible electrode,
wherein the first and second triboelectric layers cover a same area, and the first and second triboelectric layers are located between the first and second flexible electrodes, and the second triboelectric layer keeps a distance from the first triboelectric layer when no external force is applied,
wherein the first triboelectric layer comprises MXene and polyvinylidene fluoride (PVDF), and the first triboelectric layer and the second triboelectric layer have different triboelectric properties and form a triboelectric nanogenerator.

2. The tactile sensor of claim 1, wherein the second triboelectric layer comprises Ag nanoparticles.

3. The tactile sensor of claim 1, wherein the first and second triboelectric layers are made of nanofibers.

4. The tactile sensor of claim 3, wherein the first triboelectric layer is a PVDF nanofiber membrane, and the second triboelectric layer is a nylon nanofiber membrane.

5. The tactile sensor of claim 1, wherein a concentration of MXene in the first triboelectric layer ranges from 0.55 weight percent to 0.65 weight percent.

6. The tactile sensor of claim 5, wherein a β-phase content of the first triboelectric layer ranges from 74% to 76%, and a breaking strength of the first triboelectric layer ranges from 13.5 MPa to 14.5 MPa, and the β-phase content is calculated with a formula:
$$\frac{{Abr}_{β}}{( \frac{{k}_{β}}{{k}_{α}} ) {Abr}_{α} + {Abr}_{β}} ,$$
where Abr_{α} is an absorption intensity at wavenumber 762 cm⁻¹, Abr_{β} is an absorption intensity at wavenumber 840 cm⁻¹, k_{α} is an absorption factor at the corresponding wavenumber 762 cm⁻¹, and k_{α}=6.1×10⁴ cm²·mol⁻¹, k_{β} is an absorption factor at the corresponding wavenumber 840 cm⁻¹, and k_{β}=7.7×10⁴ cm²·mol⁻¹.

7. The tactile sensor of claim 5, wherein, at 25 degree Celsius and 50% relative humidity, a water vapor transfer rate (WVTR) of the first triboelectric layer ranges from 19 kg·m⁻²·d⁻¹ to 20 kg·m⁻²·d⁻¹, and an air permeability (AP) of the first triboelectric layer ranges from 5 mL·s⁻¹ to 6 mL·s⁻¹, a WVTR of the second triboelectric layer ranges from 18.5 kg·m⁻²·d⁻¹ to 19.5 kg·m⁻²·d⁻¹, and AP of the second triboelectric layer ranges from 1 mL·s⁻¹ to 2 mL·s⁻¹.

8. A touch device, comprising:
a plurality of tactile sensors of claim 1;
an amplifier;
a filter;
a sensor processing unit (SPU);
a microcontroller unit (MCU);
a wireless transmitter; and
a plurality of flexible wires connecting the tactile sensors, the amplifier, the filter, the SPU, the MCU, and the wireless transmitter.

9. The touch device of claim 8, wherein shapes of the first and second triboelectric layers of every tactile sensor are squares with the same dimension, and each side of every square ranges from 1 cm to 2 cm, and a 1 cm gap is formed between every two tactile sensors.

10. A manufacturing method of a tactile sensor, comprising:
preparing a first triboelectric layer made of a first mixture;
preparing a second triboelectric layer;
disposing the first triboelectric layer on a first flexible electrode;
disposing the second triboelectric layer on a second flexible electrode; and
covering the first flexible electrode with the second flexible electrode,
wherein the first and second triboelectric layers cover a same area, and the first and second triboelectric layers are located between the first and second flexible electrodes, and the second triboelectric layer keeps a distance from the first triboelectric layer when no external force is applied,
wherein the first mixture comprises MXene and PVDF, and the first triboelectric layer and the second triboelectric layer have different triboelectric properties and form a triboelectric nanogenerator.

11. The manufacturing method of claim 10, wherein the step of preparing the first triboelectric layer comprises:
adding MXene powder and PVDF particles into a first solvent and form the first mixture;
forming a first membrane with the first mixture through electrospinning; and
exsiccating the first membrane and form the first triboelectric layer.

12. The manufacturing method of claim 10, wherein the step of preparing the second triboelectric layer comprises:
adding nylon 6,6 particles into formic acid (FA) and form a second mixture;
adding AgNO₃ into the second mixture and wrap the second mixture with an opaque layer;
vigorously stirring the second mixture;
forming a second membrane with the second mixture through electrospinning; and
exsiccating the second membrane and form the second triboelectric layer.

13. The manufacturing method of claim 10, wherein the second triboelectric layer comprises Ag nanoparticles.

14. The manufacturing method of claim 10, wherein a concentration of MXene in the first triboelectric layer ranges from 0.55 weight percent to 0.65 weight percent.

15. The manufacturing method of claim 14, wherein a β-phase content of the first triboelectric layer ranges from 74% to 76%, and a breaking strength of the first triboelectric layer ranges from 13.5 MPa to 14.5 MPa, and the β-phase content is calculated with a formula:
$$\frac{{Abr}_{β}}{( \frac{{k}_{β}}{{k}_{α}} ) {Abr}_{α} + {Abr}_{β}} ,$$
where Abr_{α} is an absorption intensity at wavenumber 762 cm⁻¹, Abr_{β} is an absorption intensity at wavenumber 840 cm⁻¹, k_{α} is an absorption factor at the corresponding wavenumber 762 cm⁻¹, and k_{α}=6.1×10⁴ cm²·mol⁻¹, k_{β} is an absorption factor at the corresponding wavenumber 840 cm⁻¹, and k_{β}=7.7×10⁴ cm²·mol⁻¹.

16. The manufacturing method of claim 14, wherein, at 25 degree Celsius and 50% relative humidity, a water vapor transfer rate (WVTR) of the first triboelectric layer ranges from 19 kg·m⁻²·d⁻¹ to 20 kg·m⁻²·d⁻¹, and an air permeability (AP) of the first triboelectric layer ranges from 5 mL·s⁻¹ to 6 mL·s⁻¹, a water vapor transfer rate (WVTR) of the second triboelectric layer ranges from 18.5 kg·m⁻²·d⁻¹ to 19.5 kg·m⁻² d⁻¹, and an air permeability (AP) of the second triboelectric layer ranges from 1 mL·s⁻¹ to 2 mL·s⁻¹.
